(19) United States
(12) Patent Application Publication
(10) Pub. No.: US 2009/0214321 A1
(43) Pub. Date: Aug. 27, 2009

(54) SELF-DRILLING SCREW AND METHOD OF MAKING THE SAME

(75) Inventors: Hsi-Yuan WANG, Changhua Hsien (TW); Chih-Chang WANG, Changhua Hsien (TW)

Correspondence Address: MCNEES WALLACE & NURICK LLC, 100 PINE STREET, P.O. BOX 1166, HARRISBURG, PA, 17108-1166, US

(73) Assignee: SUN THROUGH INDUSTRIAL CO., LTD., Changhua (TW)

(21) Appl. No.: 12/036,854

(22) Filed: Feb. 25, 2008

(51) Int. Cl. F16B 25/10; B21H 3/00

(52) U.S. Cl. 411/387.6; 470/9

(57) ABSTRACT

A self-drilling screw includes a head portion, a shank portion having an externally threaded section, and a drilling portion opposite to the head portion. The drilling portion has a main section and a tip section, two flutes extending helically through the main and tip sections, and two lands extending helically between the flutes. Each of the lands has a tapered face extending in the tip section and between the flutes, and a drilling edge formed on one end of the tapered face.

### BACKGROUND OF THE INVENTION

1. Field of the Invention

This invention relates to a screw, more particularly to a self-drilling screw and a method of making the same.

2. Description of the Related Art

Referring to FIGS. 1 and 2, a conventional self-drilling screw 1 is produced by first forging a top end of a cylindrical blank 10 to form a head portion 11, after which a bottom end of the blank 10 is disposed between a pair of matching dies (I) to undergo another forging process. Through forming cavities (I1) of the dies (I), the bottom end of the blank 10 is forged to form a drilling tip 12 having two tapered end faces 121, two symmetrical and inclining flutes 122, a chisel edge 123, and a cutting edge 124. Finally, an intermediate portion of the blank 10 is thread-rolled to form an externally threaded section 13. During a screwing operation, through the chisel edge 123 and the cutting edge 124 of the self-drilling screw 1 that initially intrude into a workpiece, the externally threaded section 13 of the screw 1 is gradually guided into the workpiece so as to be fastened to the same. Shavings produced during the screwing operation are discharged through the flutes 122.

Because the two flutes 122 are substantially straight though slanting, the drilling speed of the screw 1 is slow, and the discharging of the shavings is not smooth, especially when the workpiece is bored deeply. Further, since the shavings cannot be discharged smoothly, high temperature heat will be produced at the drilling tip 12, thereby causing the drilling tip 12 to become dull. Moreover, the drilling tip 12 can be stuck in the workpiece and become ruptured.

### SUMMARY OF THE INVENTION

Therefore, the object of the present invention is to provide a self-drilling screw and a method of making the same, in which the self-drilling screw allows for smooth boring and discharging operations.

According to one aspect of this invention, a method of making a self-drilling screw comprises the steps of: (a) forging a rod-shaped blank to form a head portion, a drilling portion opposite to the head portion, and a shank portion between the head and drilling portions, the drilling portion having two flutes formed respectively on two opposite sides of the drilling portion, and two lands each formed between the flutes; (b) twisting the drilling portion by clamping the shank portion and an end section of the drilling portion, and by rotating the shank portion and the end section relative to each other, so that the flutes and the lands are twisted to extend helically; and (c) forming an externally threaded section on the shank portion of the blank.

According to another aspect of this invention, a self-drilling screw comprises a head portion, a shank portion having an externally threaded section, and a drilling portion opposite to the head portion. The drilling portion has a main section and a tip section, two flutes extending helically through the main and tip sections, and two lands extending helically between the flutes. Each of the lands has a tapered face extending in the tip section and between the flutes, and a drilling edge formed on one end of the tapered face.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic view of a method of making a conventional self-drilling screw;

FIG. 2 is a perspective view of the conventional self-drilling screw produced according to the method of FIG. 1;

FIG. 3 is a perspective view of a self-drilling screw according to the preferred embodiment of the present invention;

FIG. 4 is a schematic bottom view of the preferred embodiment;

FIG. 5 is a sectional view of the preferred embodiment;

FIG. 6 is a flow chart, illustrating the steps involved in making the self-drilling screw according to the preferred embodiment of the present invention;

FIG. 7 is a perspective view of a cylindrical blank after forging;

FIG. 8 illustrates the blank being clamped by two clamping tools;

FIG. 9 illustrates how a drilling portion of the blank is formed;

FIG. 10 illustrates the self-drilling screw of the present invention in a state of use; and

FIG. 11 is a sectional view, illustrating how shavings are discharged through second flutes of the self-drilling screw of the present invention.

### DETAILED DESCRIPTION OF THE PREFERRED EMBODIMENT

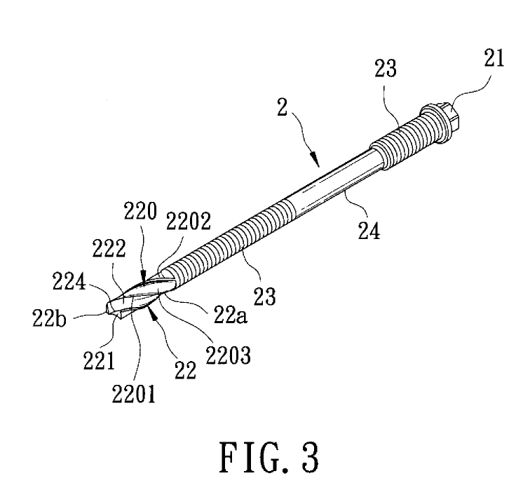

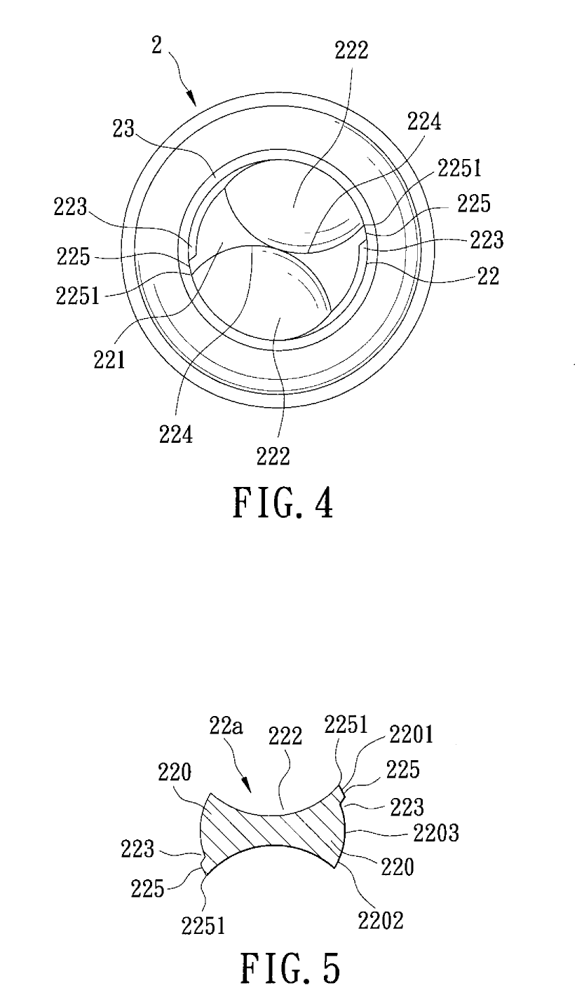

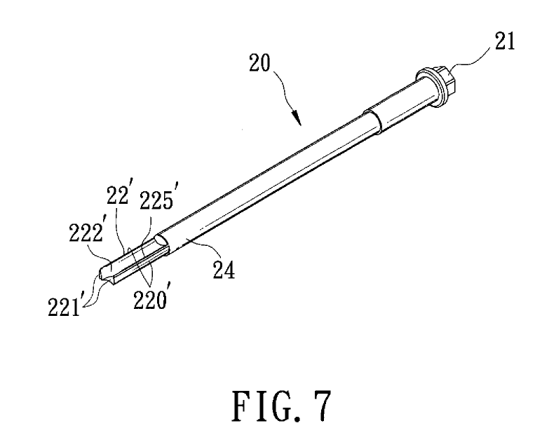

Referring to FIGS. 3 to 5, a self-drilling screw 2 according to the preferred embodiment of the present invention is shown to comprise a head portion 21, a drilling portion 22 opposite to the head portion 21, and a shank portion 24 between the head and drilling portions 21, 22 and having two spaced-apart externally threaded sections 23. Referring to FIG. 7, there is shown a blank 20 for forming the screw 2 which has a preform 22′ for the drilling portion 22. The preform 22′ has two opposite tapered faces 221′, two first flutes 222′ (only one is visible), two lands 220′ extending between the two first flutes 222′, and two protruding lips 225′ (only one is visible) formed respectively on the two lands 220′ adjacent to the respective first flutes 222′.

The drilling portion 22 is formed by twisting the preform 22′ to thereby result in a main section (22a), a tip section (22b), two first flutes 222 extending helically through the main and tip sections (22a, 22b), and two lands 220 extending helically between the first flutes 222. Each of the first flutes 222 turns helically by an angle approximately equal to 180 degrees, but is not limited thereto.

Each of the lands 220 has a tapered face 221 extending in the tip section (22b) and between the first flutes 222, a drilling edge 224 formed on one end of the tapered face 221, and a land face 2203 extending helically in the main section (22a) between first and second ends 2201, 2202. The first end 2201 is adjacent to one of the first flutes 222, and the second end 2202 is spaced apart angularly from the first end 2201, and is adjacent to the other one of the first flutes 222. Each land face 2203 is recessed to form a second flute 223 that extends helically in proximity to the first end 2201, and a lip 225 that projects helically between the second flute 223 and the first flute 222. The lip 225 is immediately adjacent to the second flute 223. The land face 2203 is stepped between the lip 225 and the second flute 223. The lip 225 has a cutting edge 2251 extending helically on the first end 2201 that is opposite to the second flute 223.

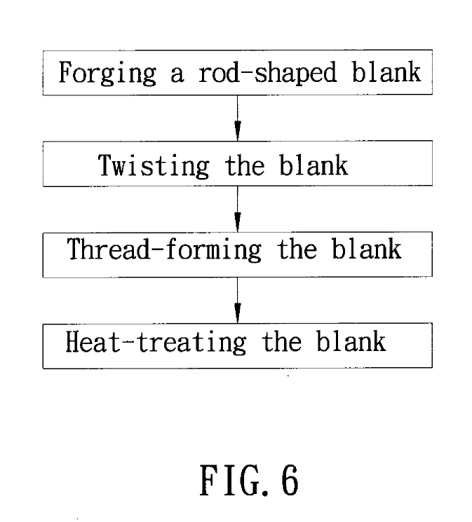

Referring to FIG. 6, the method of making the self-drilling screw 2 of the present invention is shown to comprise the steps of forging, twisting, thread-forming, and heating.

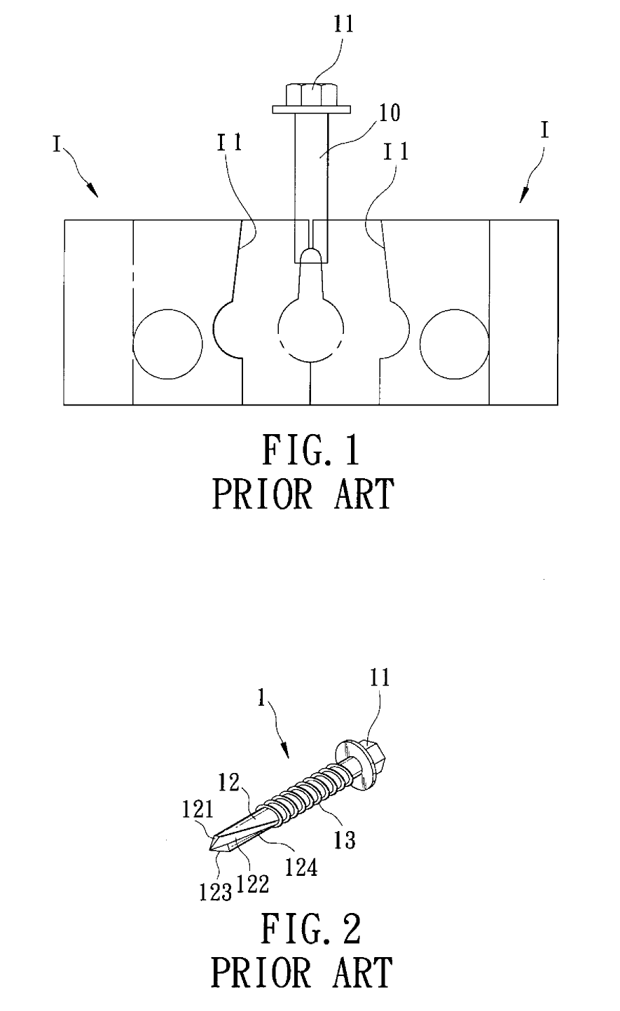

Referring back to FIG. 7, a top end of the cylindrical blank 20 is forged to form the head portion 21, and a bottom end thereof is disposed between a pair of matching dies, which are similar to those shown in FIG. 1, to undergo another forging process to form the preform 22′.

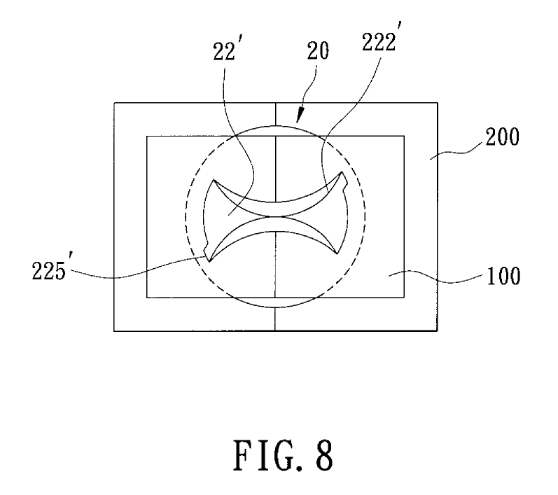

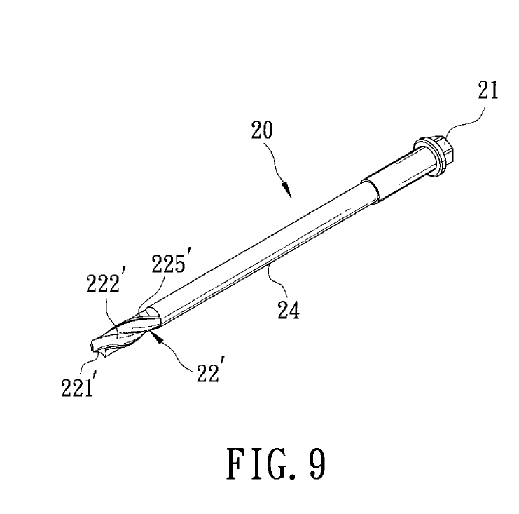

After the forging process, with reference to FIGS. 8 and 9, the shank portion 24 of the blank 20 and an end section of the preform 22′ are clamped fixedly by two clamping tools 100 and 200, after which one of the clamping tools 100 or 200 is rotated by about 180° (or may be rotated by another angle) so as to twist and rotate the shank portion 24 of the blank 20 and an end section of the preform 22′ relative to each other. As such, the first flutes 222′, the lands 220′, and the lips 225′ of the preform 22′ are twisted to extend helically.

With reference to FIG. 9, in combination with FIG. 3, the shank portion 24 of the blank 20 is then formed with two spaced-apart externally threaded sections 23 by using thread-rolling dies (not shown) to perform a thread-rolling process. Afterwards, the blank 20 is heat-treated by subjecting the blank 20 to a suitable temperature for hardening the same. The self-drilling screw 2 of the present invention is thus produced. The method of the present invention may be conducted automatically and continuously to achieve a high rate of mass production of the screw 2.

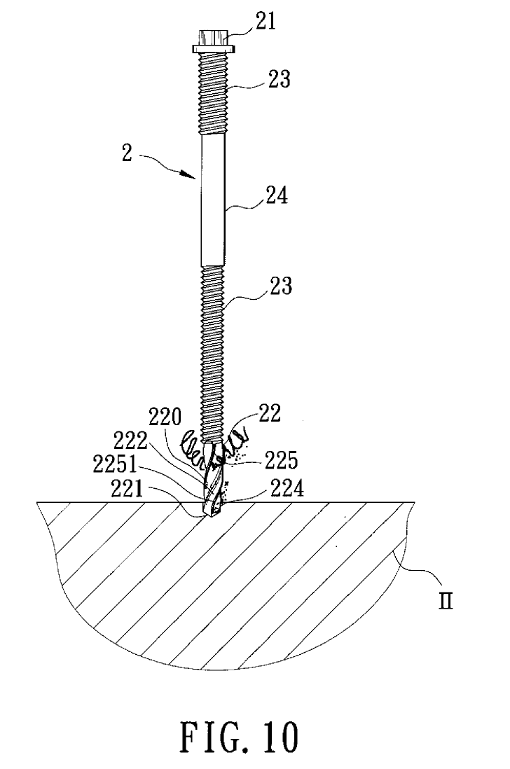

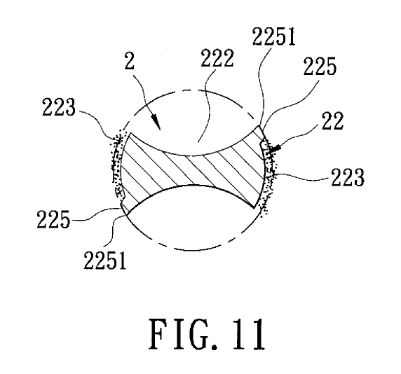

Referring to FIGS. 10 and 11, during a screwing operation of the self-drilling screw 2, the drilling edge 224 and the cutting edge 2251 of the screw 2 first bore into a workpiece (II), after which one of the externally threaded sections 23 of the screw 2 is guided threadedly and gradually into the workpiece (II). Simultaneously, shavings produced during the screwing operation are moved upwardly along the drilling portion 22 through the helically extending first flutes 222, and are discharged through the first flutes 222. Further, through the presence of the second flutes 223 in the lands 220, excessive boring and overheating of the drilling portion 22 due to sticking of the shavings may be prevented. As such, the present invention may achieve stable positioning effects.

From the aforementioned description, the advantages of the present invention may be summarized as follows:

1. Since the drilling portion 22 of the self-drilling screw 2 has the helically extending first flutes 222 and the helically extending cutting edges 2251, cutting and discharging operations during the screwing operation of the self-drilling screw 2 are smooth, and the resistance to cutting is minimized. Hence, the fastening operation of the screw 2 is fast to thereby enhance the process efficiency of the screw 2.

2. Since the first flutes 222 are helical, the discharging function of the same is good, so that rupture of the drilling portion 22 due to unsmooth discharging of the shavings can be overcome.

3. The first flutes 222 are formed helically by rotating one of the clamping tools 100, 200, so that processing of the first flutes 222 is simple. Also, manufacturing costs are minimized, ultimately increasing the competitiveness of the self-drilling screw 2.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

We claim:

1. A method of making a self-drilling screw, comprising:
(a) forging a rod-shaped blank to form a head portion, a drilling portion opposite to the head portion, and a shank portion between the head portion and the drilling portion, the drilling portion having two flutes formed respectively on two opposite sides of the drilling portion, and two lands each formed between the flutes;
(b) twisting the drilling portion by clamping the shank portion and an end section of the drilling portion, and by rotating the shank portion and the end section relative to each other, so that the flutes and the lands are twisted to extend helically; and
(c) forming an externally threaded section on the shank portion of the blank.

2. The method of claim 1, wherein, in step (b), the shank portion and the end section are rotated relative to each other by an angle of substantially 180°.

3. The method of claim 1, further comprising the step of heat treating the blank after step (c).

4. A self-drilling screw comprising:
a head portion;
a shank portion having an externally threaded section; and
a drilling portion opposite to said head portion, said drilling portion having a main section and a tip section, two first flutes extending helically through said main and tip sections, and two lands extending helically between said first flutes, each of said lands having a tapered face extending in said tip section and between said first flutes, and a drilling edge formed on one end of said tapered face.

5. The self-drilling screw of claim 4, wherein each of said first flutes turns helically by an angle approximately equal to 180 degrees.

6. The self-drilling screw of claim 4, wherein each of said lands further includes a land face extending helically in said main section between said first flutes and having a first end which is adjacent to one of said first flutes, and a second end which is spaced apart angularly from said first end and which is adjacent to the other one of said first flutes, said land face being recessed to form a second flute that extends helically in proximity to said first end, and a lip that projects helically between said second flute and one of said first flutes, said lip being immediately adjacent to said second flute, said land face being stepped between said lip and said second flute.
